(19) United States
(12) Patent Application Publication
(10) Pub. No.: US 2016/0352394 A1
(43) Pub. Date: Dec. 1, 2016

(54) SYSTEM AND METHOD IMPLEMENTING SPATIAL MULTIPLEXING AND JOINT COORDINATED MULTIPOINT TRANSMISSION OF DATA

(71) Applicant: Telefonaktiebolaget L M Ericsson (publ), Stockholm (SE)

(72) Inventors: Gary Boudreau, Kanata (CA); Hossein Seyedmehdi, Toronto (CA)

(73) Assignee: Telefonaktiebolaget L M Ericsson (publ), Stockholm (SE)

(21) Appl. No.: 14/362,788

(22) PCT Filed: May 9, 2014
(86) PCT No.: PCT/IB2014/061346

§ 371 Date: Jun. 4, 2014

(51) Int. Cl. H04B 7/02; H04W 72/12; H04L 5/14; H04B 7/06; H04J 11/00; H04B 7/04; H04L 5/00

(52) U.S. Cl. CPC H04B 7/024; H04B 7/0413; H04W 72/1215; H04L 5/005; H04B 7/0632; H04J 11/00; H04L 5/14; H04L 5/0055; H04W 88/12

(57) ABSTRACT

According to some embodiments, a method in a wireless communication device includes exchanging, with all wireless devices within a cluster of wireless devices, data to be transmitted to each serving node serving a wireless device within the cluster of wireless devices. The cluster is formed based on one or more metrics. The data exchanged with all wireless devices in the cluster is concatenated into a multiplexed data block. A virtual multi-input multi-output (VMIMO) array is formed with the antennas of all wireless devices within the cluster, and the VMIMO array is used to transmit the multiplexed data block.

### TECHNICAL FIELD

Particular embodiments relate generally to wireless communications and more particularly to a system and method implementing spatial device-to-device multiplexing and joint coordinated multipoint transmission and reception of data in a wireless network.

### BACKGROUND

Demand for wireless communications has put persistent pressure on wireless network operators to improve the capacity of communication networks. In the case of 3GPP and WiFi wireless networks, carrier spectrum is limited. To improve the spectral efficiency (Mbps/MHz), scarce radio resources may be reused aggressively in neighboring cells. As a result, inter-cell interference has become a main source of signal disturbance, limiting not only the service quality to users at the cell edges, but also the overall system throughput.

Solutions for improving spectral efficiency may include interference cancellation via enhanced receiver design or intelligent scheduling, multiple input multiple output techniques that rely on multiples antennas in one wireless device, and/or micro-diversity techniques such as Coordinated Multi-Point (CoMP) transmission and reception of data. For example, CoMP reception in the uplink may be used to mitigate inter-cell interference in International Mobile Telecommunications (IMT) Advanced systems. For the uplink (UL), CoMP reception differs from reception in a conventional system in that uplink signals are received at multiple, geographically dispersed base stations, and then sent across backhaul communication links to a common location for join processing (e.g., to the serving base station). In effect, this architecture forms a “super-cell,” called a CoMP cell, where uplink signals that would have been treated by a conventional cell as inter-cell interference are instead treated by the CoMP cell as desired signals. The mitigation in inter-cell interference may significantly improve system performance, especially for users near the edge of a conventional cell.

Sending the received uplink signals across backhaul communication links for joint processing, however, can require significant and potentially prohibitive backhaul bandwidth. For many transmissions, the cooperating node is under a stringent time deadline to deliver the CoMP payload to the serving node for processing. For example, it is desirable that the uplink signals received by a cooperating node be processed and the CoMP payload delivered to the serving node within the time deadline for Hybrid Automatic Repeat Request (HARQ). In Long Term Evolution (LTE) systems, the HARQ timing is typically set to 4 ms, so that the HARQ process can assist in exploiting the short term behavior of the wireless channel. Usual solutions deliver the CoMP payload with a latency of less than 500 μs, which allows the payload to be useful to the serving cell within the HARQ deadline. The requirement for low latencies drives the peak data rates on the backhaul and requires very high bandwidth on the backhaul.

Even though LTE is by default an asynchronous network, for optimal benefit of CoMP, synchronization of the eNBs in the CoMP cooperating set will serve to maximize the attainable peak and aggregate throughputs. This may result in CoMP payloads from many different nodes being transmitted over the backhaul at the same time causing peak congestion. The average utilization of the links will be low, while the short peaks drive the bandwidth requirement and link costs. Furthermore, existing solutions drive the requirements for links with very high bandwidth to be deployed such that the resultant peak data rates of the latency constrained CoMP payload can be met.

### SUMMARY

In particular example implementations, the proposed solutions may combine local device-to-device (D2D) spatial multiplexing with joint coordinated multipoint (CoMP) transmission and reception of data. Other embodiments may combine local device to device spatial multiplexing with heterogeneous networks and CoMP. Still other embodiments may combine local device to device spatial multiplexing with heterogeneous networks and FFR. Other embodiments may combine macro device to device spatial multiplexing with FFR.

According to some embodiments, a wireless communication device includes one or more processors and a memory containing instructions executable by the one or more processors. The wireless communication device transmits a referencing signal to each of a plurality of wireless devices within range of the wireless communication device. Referencing signals are received from the plurality wireless devices. Based on similarity metrics, a device-to-device cluster is formed with a portion of the wireless devices. A data message is received via a device-to-device communication from each of the wireless device within the device-to-device cluster. The data messages are intended for a radio network node servicing the wireless device. A composite message is formed of the data messages. A virtual multi input multi output array is formed with the wireless devices within the device-to-device cluster, and the composite data message is transmitted from the virtual multi input multi output array to the radio network node.

According to some embodiments, a method in a wireless device includes transmitting a referencing signal to each of a plurality of wireless devices within range of the wireless communication device. Reference signals are received from the wireless devices. Based on one or more similarity metrics, a device-to-device cluster is formed with a portion of the wireless devices. Data messages are received from each of the wireless devices within the device-to-device cluster via a device-to-device communication data messages. The data messages are intended for a radio network node servicing the wireless device. A composite data message is formed of each of the plurality of data messages. A virtual multi input multi output array is formed with the wireless devices within the device-to-device cluster. The composite data message is transmitted to the radio network node.

According to some embodiments, a wireless communication device within a cluster of wireless devices includes a transceiver, one or more processors, and an antenna. The cluster is formed based on one or more metrics. The transceiver is adapted to exchange with all wireless devices within the cluster data to be transmitted to respective serving nodes. The one or more processors concatenates data exchanged with all devices in the cluster into a multiplexed data block. An antenna is adapted to form a virtual multi-input multi-output (VMIMO) array with antennas of all wireless devices within the cluster and transmit the multiplexed data block.

According to some embodiments, a method in a wireless communication device includes exchanging, with all wireless devices within a cluster of wireless devices, data to be transmitted to each serving node serving a wireless device within the cluster of wireless devices. The cluster is formed based on one or more metrics. The data exchanged with all wireless devices in the cluster is concatenated into a multiplexed data block. A virtual multi-input multi-output (VMIMO) array is formed with the antennas of all wireless devices within the cluster, and the VMIMO array is used to transmit the multiplexed data block.

According to some embodiments, a method in a radio network node includes transmitting, to a plurality of wireless devices, a first request for initiation of a discovery mode. Channel quality information is received from each of the plurality of wireless devices. The channel quality information indicates a quality of each device-to-device communication channel. Based on one or more similarity metrics applied to the channel quality information received from each wireless device, a portion of the plurality of wireless devices is selected for formation of a device-to-device cluster. A second request for the formation of the device-to-device cluster is transmitted to the wireless devices selected for the formation of the device-to-device cluster. A composite data message is received from a virtual MIMO array formed by the device-to-device cluster.

According to some embodiments, a radio network node includes one or more processors and a memory containing instructions executable by the one or more processors. A first request for initiation of a discovery mode is transmitted by the radio network node to a plurality of wireless devices. Channel quality information is received from each of the plurality of wireless devices. The channel quality information indicates a quality of each device-to-device communication channel. Based on one or more similarity metrics applied to the channel quality information received from each wireless device, a portion of the plurality of wireless devices is selected for formation of a device-to-device cluster. A second request for the formation of the device-to-device cluster is transmitted to the wireless devices selected for the formation of the device-to-device cluster. A composite data message is received from a virtual MIMO array formed by the device-to-device cluster.

According to some embodiments, a system includes a first cluster of a first plurality of wireless devices formed based on one or more similarity metrics. Each of the first plurality of wireless devices exchanges data with all wireless devices within the first cluster. The data exchanged with all devices in the first cluster is concatenated into a multiplexed data block. A virtual multi-input multi-output (VMIMO) array is formed with antennas of all wireless devices within the first cluster and transmit the multiplexed data block. At least one radio network node receives the composite data message from the virtual MIMO array formed by first cluster of wireless devices.

Some embodiments of the disclosure may provide one or more technical advantages. For example, certain embodiments may provide a more spectrally efficient implementation of Coordinated Multi-Point (CoMP) transmission of data. Another technical advantage may be improvement of individual and aggregate throughput in cellular systems (both LTE and Wi-Fi) by exploiting idle and active wireless devices to retransmit signals from active wireless devices. In addition to improving capacity and throughput, particular embodiments may also aid in eliminating coverage holes for wireless devices in poor coverage areas.

Still another technical advantage may be the mitigation of the high backhaul costs associated with using CoMP. For example, from a base station or other radio network node perspective, additional processing requirements related to UL and DL CoMP may be reduced or eliminated. According to particular embodiments, the clustering algorithm used to achieve the virtual MIMO gains may be implemented in a distributed manner that minimizes computational load at each radio network node. The clustering algorithm may also minimize bandwidth requirements between radio network nodes to achieve CoMP type gains.

Still another technical advantage may be the alleviation of interference by aggressor networks in a Wi-Fi implementation or co-channel interference for cell edge users in a 3GPP implementation.

Some embodiments may benefit from some, none, or all of these advantages. Other technical advantages may be readily ascertained by one of ordinary skill in the art.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example of a network;

FIG. 2 is a block diagram illustrating an example network implementing D2D spatial multiplexing with coordinated multipoint transmission and reception of data;

FIG. 3 is a flow chart illustrating example embodiments of a method for implementing D2D spatial multiplexing with macro coordinated multipoint transmission and reception of data;

FIG. 4 is a flow chart illustrating example embodiments of another method for implementing D2D spatial multiplexing with macro coordinated multipoint transmission and reception of data;

FIG. 5 is a signaling diagram illustrating an exchange of signals during the discovery phase of an embodiment of a network;

FIG. 6 is a block diagram illustrating an example digital modulation reference signal for spatially multiplexed device-to-device communication;

FIG. 7 is a block diagram illustrating an example network implementing D2D spatial multiplexing in combination with macro cell coordinated multipoint transmission and reception of data and fractional frequency reuse;

FIG. 8 is a block diagram illustrating an example network implementing D2D spatial multiplexing with macro and small cell coordinated multipoint transmission and reception of data;

FIG. 9 is a block diagram illustrating an example network implementing D2D spatial multiplexing with macro and small cell coordinated multipoint transmission and reception of data and fractional frequency reuse;

FIG. 10 is a block diagram illustrating embodiments of a wireless device;

FIG. 11 is a block diagram illustrating embodiments of a radio access node; and

FIG. 12 is a block diagram illustrating embodiments of a core network node.

### DETAILED DESCRIPTION

Particular embodiments of the present disclosure may provide solutions to backhaul congestion and link costs. Specifically, wireless devices and other user equipment (UE) may be clustered to form a CoMP set in conjunction with a virtual multiport input multiport output over the cluster. Spatial multiplexing of data may be employed within clusters of active UE's using local device-to-device communication within the cluster and joint CoMP broadcasting of data on the downlink. According to other embodiments, spatial multiplexing of data may be employed with virtual multiport input multiport output (MIMO) transmission of data on the UL to exploit local device-to-device versus macro to cell edge channel capacities for overall macro cell capacity improvement.

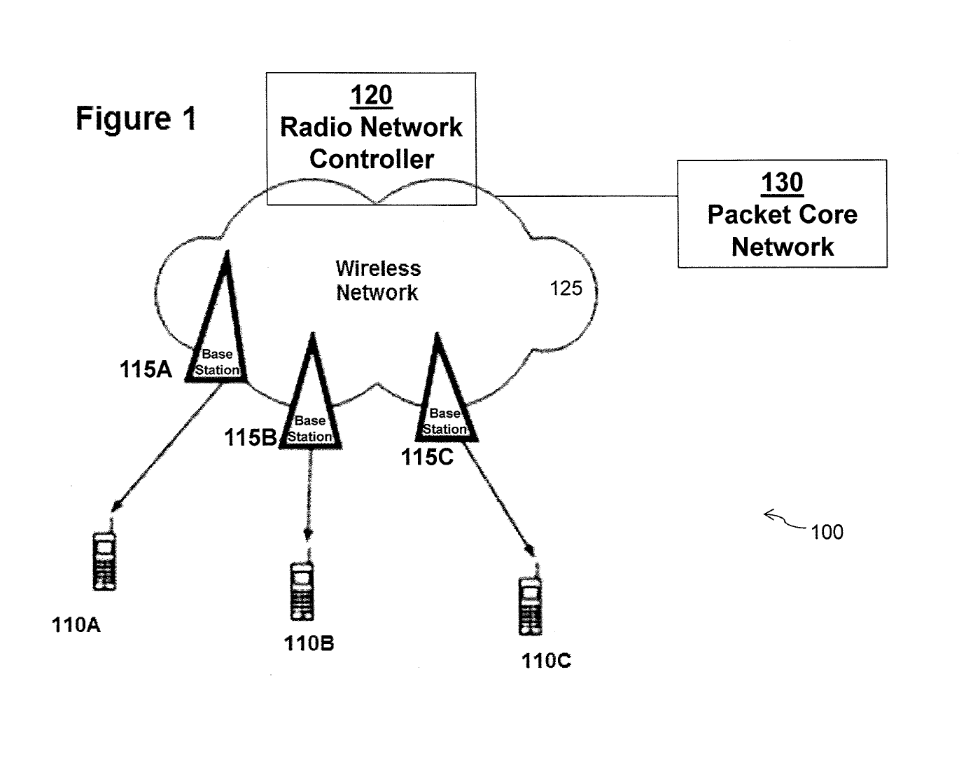

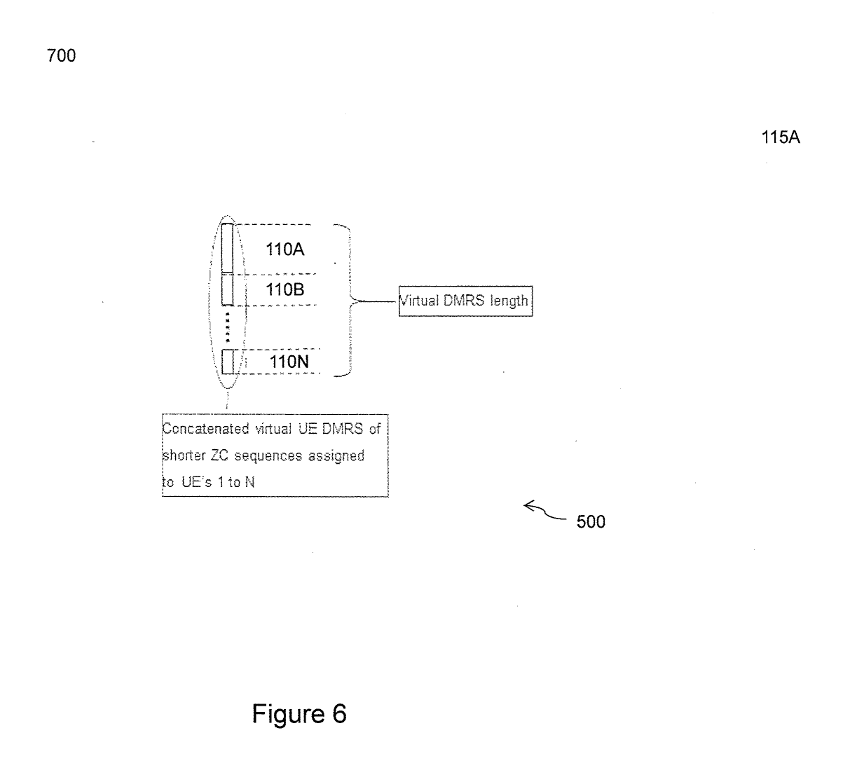

Particular embodiments are described in FIGS. 1-12 of the drawings, like numerals being used for like and corresponding parts of the various drawings. FIG. 1 is a block diagram illustrating an example of a network 100 that includes one or more wireless communication devices 110 and a plurality of network nodes. The network nodes include radio network nodes 115 and core network nodes 130. In the example, wireless communication device 110a communicates with radio network node 115a over a wireless interface. For example, wireless communication device 110a transmits wireless signals to radio network node 115a and/or receives wireless signals from radio network node 115a. The wireless signals contain voice traffic, data traffic, control signals, and/or any other suitable information.

A radio network node 115 refers to any suitable node of a radio access network/base station system. Examples include a radio access node (such as a base station or eNodeB) and a radio access controller (such as a base station controller or other node in the radio network that manages radio access nodes). Radio network node 115 interfaces (directly or indirectly) with core network node 130. For example, radio network node 115 interfaces with core network node 130 via an interconnecting network 125. Interconnecting network 125 refers to any interconnecting system capable of transmitting audio, video, signals, data, messages, or any combination of the preceding. Interconnecting network 125 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

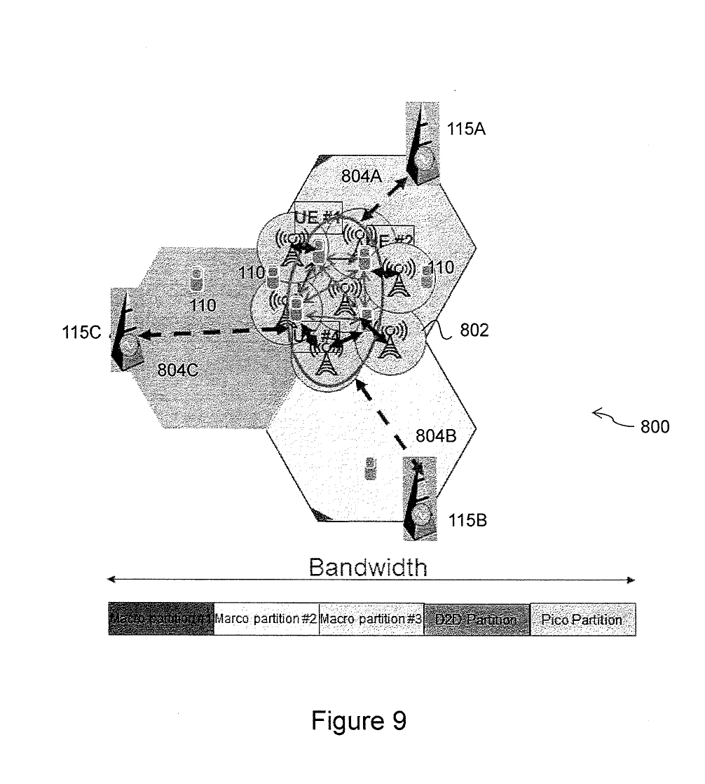

Core network node 130 manages the establishment of communication sessions and various other functionality for wireless communication device 110. Wireless communication device 110 exchanges certain signals with core network node 130 using the non-access stratum layer. In non-access stratum (NAS) signaling, signals between wireless communication device 110 and core network node 130 pass transparently through radio network nodes 120. Examples of wireless communication device 110, radio network node 120, and core network node 130 are described with respect to FIGS. 9, 10, and 11 respectively.

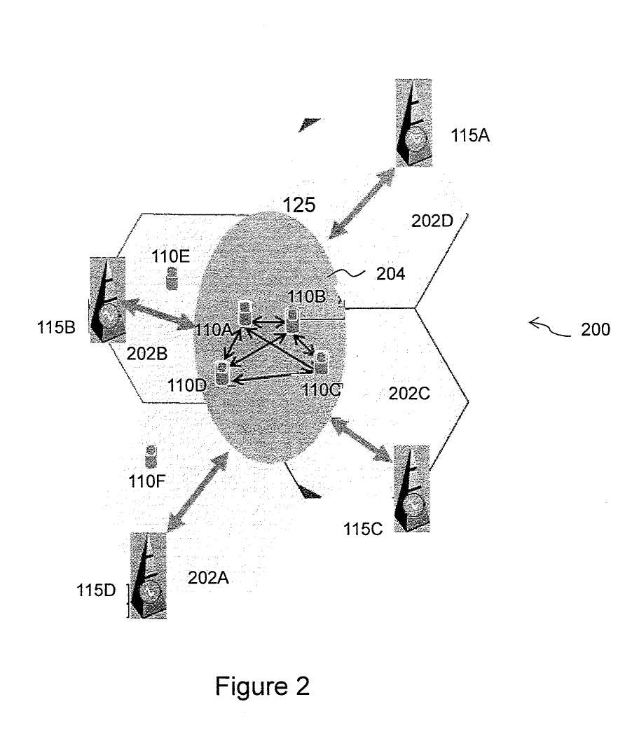

FIG. 2 is a block diagram illustrating an example network 200 implementing D2D spatial multiplexing with macro coordinated multipoint transmission and reception of data. Network 200 includes multiple radio network nodes 115A-D. Each radio network node 115A-D serves a cell 202A-D. Wireless devices 110A-F located within cells 202A-D are served by the corresponding radio network node 115A-D. For example, wireless device 110A is served by radio network node 115B when located in cell 202B. To mitigate interference resulting from data transmission, a cluster of wireless devices 110A-D form a local group 204 and exchange data with each other before jointly transmitting a composite message of the data of all the wireless devices 110 to radio network nodes 115A-D.

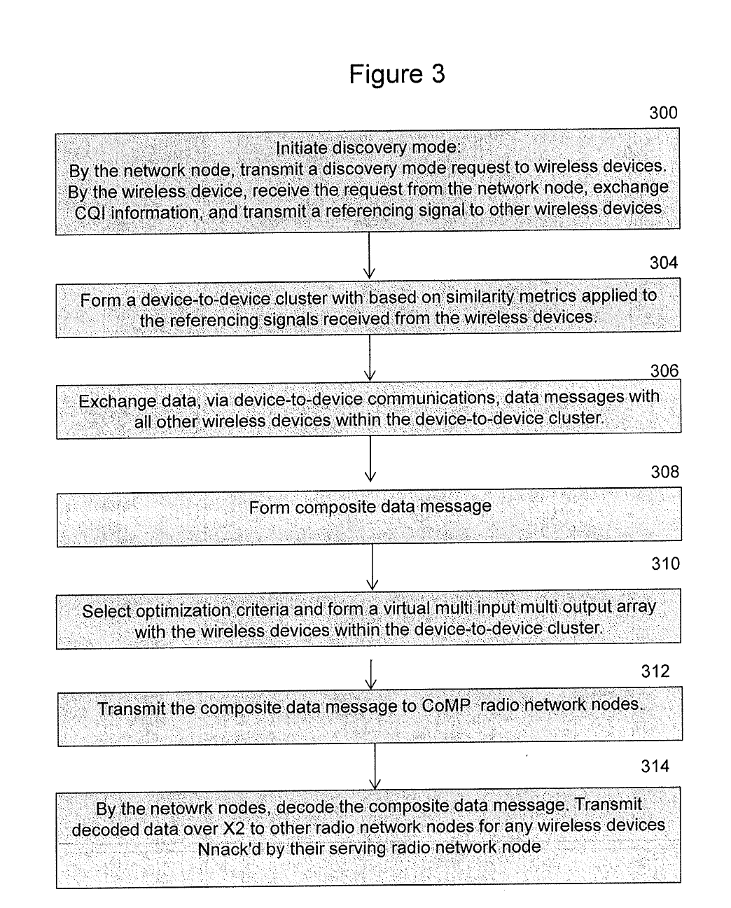

The operations of the network elements of network 200 may best be described with respect to the flowchart of FIG. 3, which depicts an example embodiment for implementing D2D spatial multiplexing with macro coordinated multipoint transmission and reception of data. As depicted, the method begins at step 300 with the discovery of wireless devices 110 to be clustered together. In this step, wireless devices 110 that are “good” candidates to be clustered together are discovered.

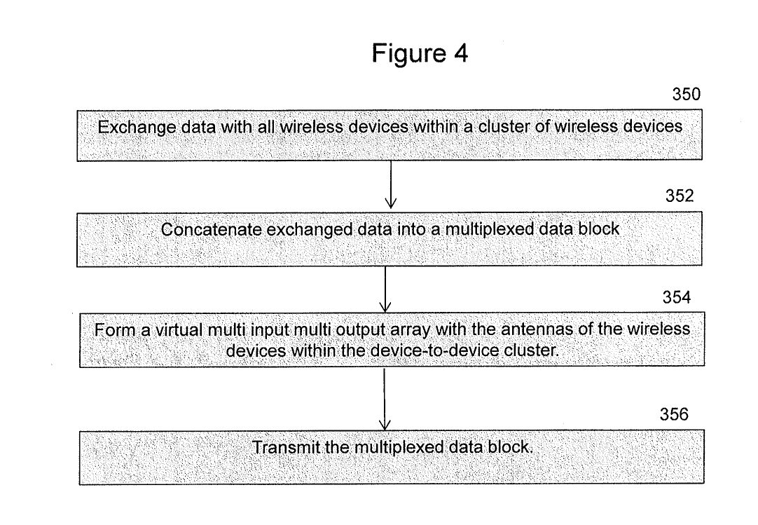

The discovery mode may be an on-going procedure that includes signals being exchanged between radio network devices 115 and wireless devices 110. FIG. 4 is a signaling diagram illustrating an exchange of signals during the discovery phase of an embodiment of a network. As depicted, a discovery mode activation signal (DMA) 402 may be transmitted from radio network node 115 to wireless devices 110. As shown DMA 402, is transmitted from radio network node 115A to wireless devices 110A-E. Upon receiving DMA 402, wireless devices 110 may activate the discovery mode.

In a particular embodiment, after receiving an activation signal from radio network node 115A, each wireless device 110A-E transmits SRS messages to all other wireless devices 110A-E in the candidate D2D cluster to allow each UE to determine the quality of the all the D2D channels within the potential D2D cluster. In addition each wireless device 110A-E may receive a request for channel quality information (RCQI) 404 from radio network node 115A to determine the channel quality between each wireless device 110A-E and the radio network node 115A. RCQI 404 may include instructions from radio network node 115A for the periodicity and bandwidth (in resource blocks) that wireless devices 110A-E will be used for SRSs 406. RCQI 404 may also indicate which channel quality indicators (CQIs) are required.

In response to RCQI 404, wireless devices 110A-E may estimate the device-to-device channel for multiple frequency ranges. Stated differently, wireless devices 110 may either have channel quality indicators (CQIs) for the whole band (by taking more frames for SRS's) or have CQI's for some sub bands and do the discovery in one (or potentially less) frame. As depicted, each wireless device 110A-E transmits the device-to-device channel frequency information to the requesting radio network device 115A in a CQI signal 408. This approach requires greater latency in the process over a parallel type approach that could exchange the required information in parallel by assigning wireless device specific resource blocks (RBs) in the same symbol for exchange of the CQI information.

Subsequently, the discovery process may include each wireless device 110A-E transmitting a SRS 406 to every other wireless device 110A-E. For example, wireless device 110A may transmit SRS 406A to wireless devices 110B-E. Likewise, wireless device 110B may transmit SRS 406B to wireless devices 110A and 110C-E. In this manner, each wireless device 110A-E transmits a SRS 406 to and receives a SRS 406 from every other wireless device 110A-E.

Returning to FIG. 3, the method for implementing spatial multiplexing with macro coordinated multipoint transmission and reception of data may continue at step 304 with the formation of device-to-device clusters. The selection of the cluster of wireless devices 110 can be based on a number of similarity metrics that will enable the clustering and multiplexing of data by wireless devices 110 to improve the aggregate signal-to-interference-plus-noise ratio (SINR) and throughput of wireless devices 110 within the cluster. In a particular embodiment, cluster group 204 may include one or more wireless 110 that are near the cell border of their respective serving radio network node 115 and, thus, have a relatively poor SINR (i.e. CQI) to the radio network node 115 but have good local device-to-device CQI with wireless devices 110 in cluster group 204.

In particular embodiments, the similarity metrics may include, but are not restricted to, the quality information received in CQIs 408 from each of wireless devices 110A-F during the discovery phase. As described above, the device-to-device CQI can be measured through local beacon type transmissions between wireless devices 110A-E. Additionally, the CQI to radio network nodes 115 can be measured for example through use of reference signal received power (RSRP) and reference signal received quality (RSRQ) measurements of common reference signal (CRS) or channel state information-reference signal (CSI-RS) transmissions.

Based on the similarity metrics, wireless devices 110 may be chosen for cluster group 204. The selection of wireless devices 110 within a given cluster 204 can be network controlled or autonomous within a cluster group 204. The autonomous cluster selection approach has the advantage of not requiring signaling to radio network nodes 115 of the network and can be implemented by one wireless device 110 serving as a cluster head (CH) for cluster group 204.

At step 306, each wireless device 110 exchanges data with every other wireless device 110 in cluster group 204. The exchanged data may include all data that the wireless devices 110 have to transmit to their respective serving radio network nodes 115. In certain embodiments, the exchange of information may be over another radio access technology (RAT) or within the same RAT and transmission bandwidth as the wireless device 110 to radio network node 115 communications. In a particular embodiment, the exchange of information may be over LTE.

Though device-to-device communication may be straight forward for TDD networks, FDD implementations may require that wireless devices 110 have an additional transceiver operating at the frequency of the DL FDD band. The need for the additional transmitter may be overcome, however, by employing half duplex FDD transmissions on the UL of an FDD band. Furthermore certain embodiments can employ asymmetrical transmission of TDD such as the use of TDD LTE configuration 0 which has 6 of 8 data transmission subframes assigned to the uplink. Note that for the reciprocal process on the DL, that TDD configuration 2 would be appropriate. In certain embodiments, the transmit power of the local device-to-device transmissions may be power controlled. For example, the transmit power may be kept at a relatively low level as compared to normal transmissions to radio network node 115. As a result, the device-to-device transmissions may not generate any significant interference to the macro radio network nodes 115 in the network. For example, wireless devices 110 clustered within tens or hundreds of meters of each other may reliably communicate with power levels 30 dB or less than wireless devices 110 communicating with radio network nodes 115 at distances on the order of kilometers.

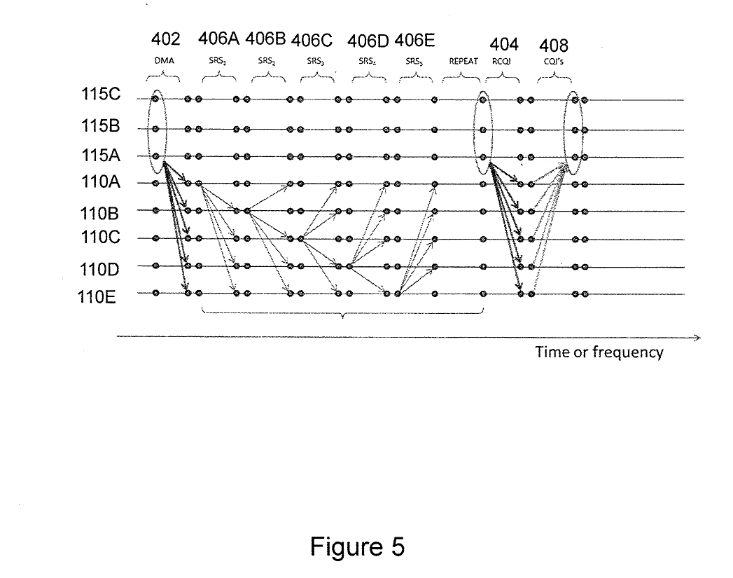

At step 308, a composite data message is formed. In particular embodiments, the formatting and order of transmission of the multiplexed data may be based on a concatenation of granted demodulation reference signals (DMRS). FIG. 5 is a block diagram illustrating an example digital modulation reference signal 500 for multiplexed device-to-device communication. The DMRS are concatenated to form a larger sequence based on the individual DMRS sequences of each wireless device 110. As depicted, a unique wireless device specific DMRS may be assigned to each wireless device 110 that spans the bandwidth of resource blocks (RBs) that are granted to wireless device 110 for transmission. The total multiplexed bandwidth in RBs will initially be based on the equivalent bandwidth of a concatenated version of the DMRS symbols. The order of the multiplexing can be chosen by a number of methods including (i) network selection, (ii) selection by the radio network node 115, (iii) selection by a wireless device 110 acting as the cluster head for cluster 204 of wireless devices 110, or (iv) a default concatenation based on an ordering from largest to smallest DMRSs.

Returning to FIG. 3, once the device-to-device cluster 204 has been formed, the wireless devices 110 within the cluster 204 have exchanged the data to be transmitted, and a composite data message has been formed, a virtual MIMO array is formed by the wireless devices 110 within the cluster group 204 at step 310. The MIMO array may be used for the transmission of the multiplexed data back to radio network nodes 115 at step 312. In particular embodiments, if there are N wireless devices 110 in cluster group 204 and M transmit antenna in each wireless device 110, there will be a total of N*M elements in the MIMO array. Thus, in a baseline case where each wireless device 110 has a single transmit antenna, each wireless device 110 comprises one element of the virtual array. However, if a wireless device 110 has M transmit antennas, then M weights would be assigned to the wireless device 110.

A number of possible approaches may be used to optimize the weights for each element of the virtual MIMO array. Given that all of wireless devices 110 in cluster group 204 will transmit all of the multiplexed data to each of radio network node 115 in the CoMP coordination set, two possible approaches may be used. In a first embodiment, the virtual MIMO weights may be selected to maximize the aggregate throughput at the output of the CoMP combining from the joint processing of radio network nodes 115 in the CoMP set. In a second embodiment, the weights of the virtual MIMO array may be optimized so as to maximize the throughput to radio network node 115 with the best CQI (i.e., SINR) in the CoMP coordination set. In this second embodiment, the virtual MIMO weights may be selected based on the best “selection diversity” of radio network nodes 115 in the CoMP coordinating set.

The composite data message is transmitted to the CoMP radio network nodes at step 312. The CoMP radio network nodes then decode the message at step 314. Once the initial device-to-device multiplex cluster has been assigned, the CQI for the joint virtual MIMO cluster may be measured at the coordinating radio network node 115 of the CoMP set. Rather than setting an individual modulation and coding scheme for each wireless device 110, the link adaptation modulation coding scheme of the device-to-device cluster can be adjusted. In certain embodiments, the modulation coding scheme of the cluster 204 can be adjusted to maximize the throughput of the device-to-device cluster to the radio network nodes 115 in the CoMP coordinating set. In a particular embodiment, the virtual MIMO weights may also be updated for each MCS update to optimize performance of the cluster group 204.

The spatial multiplexed device-to-device approach described with respect to FIG. 3 may provide certain technical advantages and benefits. A first benefit is the virtual MIMO gain due to the clustering and assigned weights of virtual wireless device. A second benefit may be referred to as a “cluster multiplexing gain for CoMP.” Specifically, for the DL, the CoMP transmission from each cell is the maximum for any wireless device 110 in cluster group 204 as opposed to individual CoMP gains for each wireless device. A third benefit may be the device-to-device cluster link adaptation gain.

Furthermore, to minimize CoMP backhaul requirements, a particular radio network node 115 may determine if the radio network node 115 can decode wireless devices 110 that the radio network node 115 is serving within the device-to-device cluster. If the radio network node 115 can decode wireless devices 110, radio network node 115 may send an ACK to other radio network nodes 115 in the CoMP set of cluster group 204. Conversely, if the radio network node 115 cannot successful decode wireless devices 110 in the CoMP set, radio network node 115 may send a NACK. Thereafter, radio network nodes 115 in the CoMP coordinating set may only send data over X2 to other radio network nodes 115 for wireless device 110 data that was not ACK'd by a serving radio network node 115. Because the full set of device-to-device data need not be transmitted, in certain embodiments, CoMP backhaul requirements may be minimized.

FIG. 4 depicts another example embodiment for implementing, in a wireless device, D2D spatial multiplexing with macro coordinated multipoint transmission and reception of data. As depicted, the method begins at step 350 when data is exchanged with all wireless devices within a cluster of wireless devices. The exchanged data may be data to be transmitted to each serving node serving of a wireless device within the cluster of wireless devices.

In a particular embodiment, the data may be exchanged using device-to-device local exchange. In some embodiments, the data may be exchanged in a manner so as not to interfere with communications exchanged between the wireless devices and their respective network nodes. For example, a wireless device 110 may use a first radio access technology (RAT) to exchange data with all wireless devices 110 in the cluster group 204 and a second RAT to exchange data with its radio network node 115. In another example, a wireless device 110 may use a first transmission bandwidth range to exchange data with wireless devices 110 within the cluster group 204 and a second transmission bandwidth range to exchange data with a radio network node 115.

In certain embodiments, the data may be exchanged using a TDD network for device-to-device local exchange of data. In other embodiments, data may be exchanged on an uplink using HD-FDD.

In certain embodiments, the cluster group 204 may be formed based on one or more metrics. For example, one or more similarity metrics may be used to select wireless devices 110 that exhibit certain similar characteristics. The metrics used to form cluster 204 of wireless devices 110 may include channel quality information (CQI) of wireless device 110 as seen by a radio network node 115 serving the wireless device 110. The CQI may be measured through the use of reference signal received power (RSRP) and reference signal received quality (RSRQ) measurements. Additionally or alternatively, the metrics used to form cluster group 204 may include local device-to-device CQI between wireless devices 110 within cluster group 204.

In a particular embodiment, the formation of the cluster of wireless devices 110 may be network controlled in response to one or more messages from radio network node 115. In other embodiments, the formation of cluster group 204 may be autonomous within the cluster of wireless devices 110 without receiving a message from a radio network node 115. For example, one of the wireless devices 110 within cluster group 204 may act as a cluster head and autonomously select, based one or more metrics, the wireless devices 110 to be included in cluster group 204.

The method continues at step 352 when the data exchanged with all wireless devices in the cluster is concatenated into a multiplexed data block. In certain embodiments, the order of the multiplexed data block may be formed using concatenated demodulated reference signaling (DMRS). At step 354, a virtual multi-input multi-output (VMIMO) array is formed with a plurality of antennas of all wireless devices within the cluster. The MIMO array may be used for the transmission of the multiplexed data back to radio network nodes 115 at step 356. As described above with regard to FIG. 3, if there are N wireless devices 110 in cluster group 204 and M transmit antenna in each wireless device 110, there may be a total of N*M elements in the MIMO array. Thus, in a baseline case where each wireless device 110 has a single transmit antenna, each wireless device 110 comprises one element of the virtual array. However, if a wireless device 110 has M transmit antennas, then M weights would be assigned to the wireless device 110.

Also similar to that described above, a number of possible approaches may be used to optimize the weights for each element of the virtual MIMO array. Given that all of wireless devices 110 in cluster group 204 will transmit all of the multiplexed data to each of radio network node 115 in the CoMP coordination set, two possible approaches may be used. In a first embodiment, the virtual MIMO weights may be selected to maximize the aggregate throughput at the output of the CoMP combining from the joint processing of radio network nodes 115 in the CoMP set. In a second embodiment, the weights of the virtual MIMO array may be optimized so as to maximize the throughput to radio network node 115 with the best CQI (i.e., SINR) in the CoMP coordination set. In this second embodiment, the virtual MIMO weights may be selected based on the best “selection diversity” of radio network nodes 115 in the CoMP coordinating set.

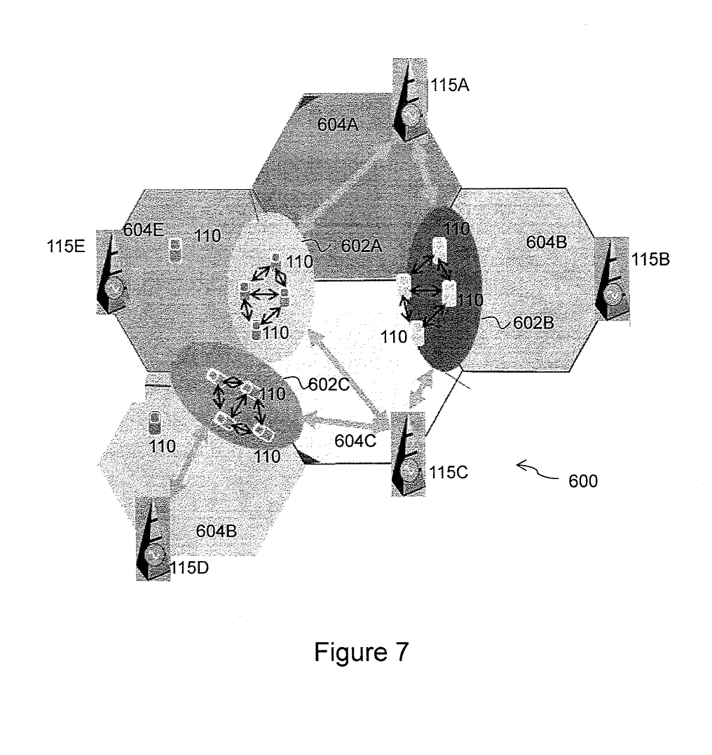

Certain modifications may be made to the system and method described above with regard to FIGS. 2, 3, and 4, respectively. For example, FIG. 7 is a block diagram illustrating an example network 600 implementing D2D spatial multiplexing with macro coordinated multipoint and fractional frequency reuse, according to certain embodiments. Similar to FIG. 2, wireless devices 110 are clustered within local device-to-device cluster groups 602A-C. As depicted, each cluster group 602A-C includes four wireless devices 110. However, network 600 can include any appropriate number of cluster groups 602A-C and each cluster group 602A-C may include any number of wireless devices 110.

Within a cluster group 602A-C, the wireless devices 110 may be serviced by differing radio network nodes 115, which may operate at different frequency ranges. For example, cluster group 602A includes wireless devices 110 serviced by neighboring radio network nodes 115A, 115C, and 115E. To reduce interference between neighboring radio network nodes, radio network nodes that border one another may operate within differing frequency ranges. Thus, radio network node 115A operates within frequency partition 604A, radio network node 114C operates within frequency partition 604C, and radio network node 115E operates within frequency partition 604E. However, radio network node 115B and radio network node 115D do not border one another and, thus, may operate in the same frequency partition 604B. As such, radio network node 115B and 115D may be said to employ frequency reuse.

Within a cluster group 602, wireless devices 110 may exchange, with each other, the data to be transmitted to radio network nodes 115. However, in the embodiment depicted in FIG. 7, fractional frequency reuse is also employed by cluster groups 602A-C to mitigate interference between the different cluster groups 602A-C and the wireless devices 110 of serving radio network nodes 115 outside the cluster groups 602A-C. For example, as described above, cluster group 602A is comprised of wireless devices 110 being served by radio network nodes 115A, 115C, and 115E, which operate within frequency partitions 604A, 604C, and 604E, respectively. As such, data communications exchanged between wireless devices 110 of cluster group 602A may operate within frequency partition 604B, which is different from frequency partitions 604A, 604B, and 604E.

In operation, components of system 600 may perform operations similar to the steps described above with regard to FIGS. 3 and 4. However, frequency reuse orthogonalizes the interference between cluster 604A and radio network nodes 115 outside of the device-to-device cluster 604A. Additionally, in certain embodiments, the virtual MIMO weights and the RBs assigned to a given cluster 604 can also be selected to minimize interference between clusters 604A-C. Specifically the RBs assigned to each cluster 604A-C can be coordinated to either be orthogonal or to minimally interfere with each other in combination with the virtual MIMO beam forming. Furthermore, each radio network node 115A-E may be part of more than one CoMP coordinating set, either as the coordinating radio network node or a participating CoMP radio network node.

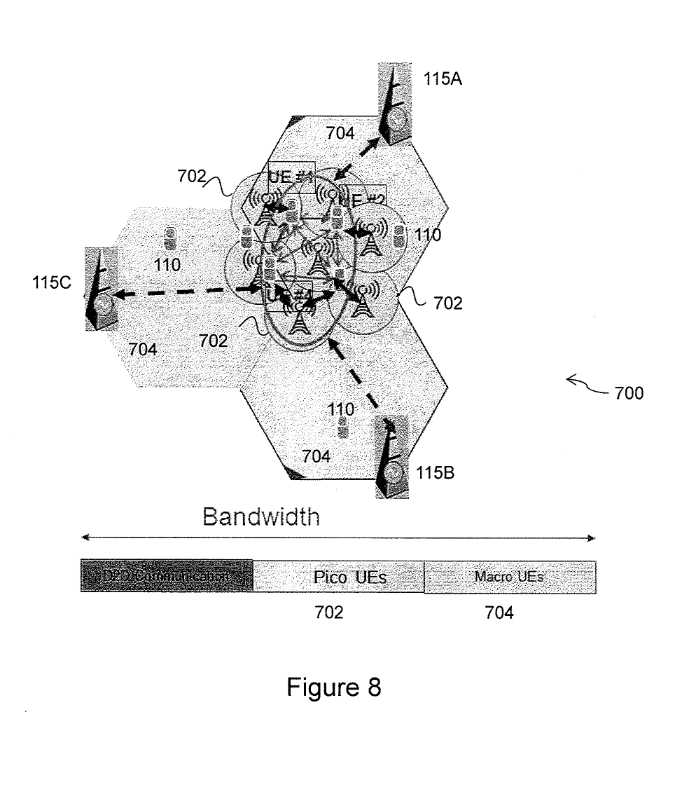

FIG. 8 illustrates certain further modifications to the above described methods and techniques. Specifically, FIG. 8 is a block diagram illustrating an example network 700 implementing D2D spatial multiplexing with macro and pico cell coordinated multipoint transmissions. The steps performed by the components of network 700 may be similar to those described above with respect to FIG. 3 with a few differences that will be described below.

As depicted, the device-to-device clusters can have a span of both intra and inter small cells 702 as well as macro cells 704. For the assignment of RBs to minimize interference, the bandwidth may be partitioned for the device-to-device cluster, the wireless devices 110 of the pico nodes 702 spanning the device-to-device cluster and the wireless devices 110 of the macro nodes 704 spanning the device-to-device cluster. Furthermore, during the device-to-device virtual MIMO and CoMP transmission, the optimization of the virtual MIMO and CoMP coordination can now be across both pico nodes 702 within range of the device-to-device cluster, as well as macro nodes 704.

Given that the device-to-device cluster area may span more than one pico node 702, an additional possible benefit may be that the virtual MIMO may be formed for both the device-to-device cluster as well as at the pico nodes 702 spanning the cluster. Thus, for example, for an uplink implementation of this embodiment, there may be a virtual MIMO gain at both the transmission side of the device-to-device cluster and the reception side of the pico CoMP set. The optimizations of the virtual MIMO weights may then be optimized jointly between the virtual transmit and receive arrays, in certain embodiments. The pico virtual MIMO array concept may also be implemented as part of a distributed antenna system solution, in particular embodiments.

In addition to the benefits noted above, the use of spatial multiplexing with macro and pico cell coordinated multipoint transmissions may also exploit the grouping of the device-to-device cluster and pico nodes 702 into a CoMP serving set to mitigate range expansion link budget issues at the boundary between the pico nodes 702 and the macro cells 704 of the coverage area.

FIG. 9 illustrates still other modifications to the above described methods and techniques. Specifically, FIG. 9 is a block diagram illustrating an example network 800 implementing D2D spatial multiplexing with macro and small cell coordinated multipoint and fractional frequency reuse. The steps performed by the components of network 800 may be similar to those described above with respect to FIG. 3 with a few differences that will be described below.

In the depicted example embodiment, the device-to-device cluster may have a span of both intra and inter small cells 802 as well as macro cells 804A-C. For the assignment of RBs to minimize interference, fractional frequency reuse may be applied across macro nodes 804A-C so that bandwidth is partitioned for the device-to-device cluster, the wireless devices 110 of the pico nodes 802 spanning the device-to-device cluster, and the three fractional frequency reuse regions for the wireless devices 110 of the macro nodes 804 spanning the device-to-device cluster. During the device-to-device virtual MIMO and CoMP transmission, the optimization of the virtual MIMO and CoMP coordination can now be across both the pico nodes 802 within range of the device-to-device cluster, as well as macro nodes 804.

As described with respect to FIG. 1 above, embodiments of network 100 may include one or more wireless communication devices 110, and one or more different types of network nodes capable of communicating (directly or indirectly) with wireless communication devices 110. Examples of the network nodes include radio network nodes 120 and core network nodes 130. The network may also include any additional elements suitable to support communication between wireless communication devices 110 or between a wireless communication device 110 and another communication device (such as a landline telephone).

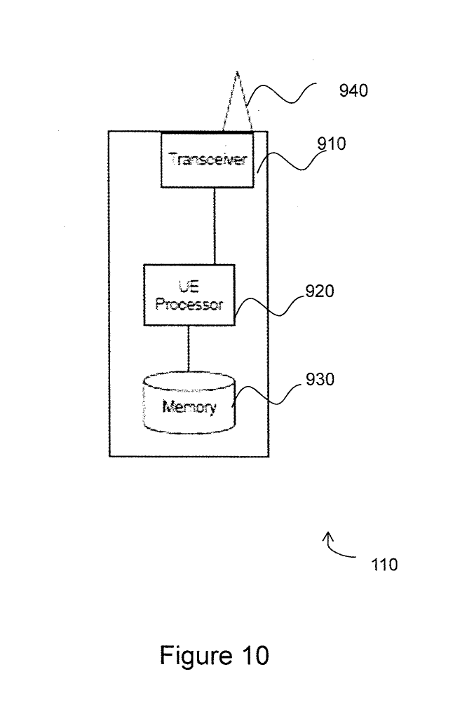

Wireless communication device 110, radio network node 120, and core network node 130 use any suitable radio access technology, such as long term evolution (LTE), LTE-Advanced, UMTS, HSPA, GSM, cdma2000, WiMax, WiFi, another suitable radio access technology, or any suitable combination of one or more radio access technologies. For purposes of example, various embodiments may be described within the context of certain radio access technologies. However, the scope of the disclosure is not limited to the examples and other embodiments could use different radio access technologies. Each of wireless communication device 110, radio network node 120, and core network node 130 include any suitable combination of hardware and/or software. Examples of particular embodiments of wireless communication device 110, radio network node 120, and core network node 130 are described with respect to FIGS. 10, 11, and 12 below, respectively.

FIG. 10 is a block diagram illustrating an example of wireless communication device 110. Examples of wireless communication device 110 include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, or another device that can provide wireless communication. A wireless communication device 110 may also be referred to as user equipment (UE), a station (STA), a mobile station (MS), a device, a wireless device, or a terminal in some embodiments. Wireless communication device 110 includes transceiver 910, processor 920, and memory 930. In some embodiments, transceiver 910 facilitates transmitting wireless signals to and receiving wireless signals from radio network node 120 (e.g., via an antenna), processor 920 executes instructions to provide some or all of the functionality described above as being provided by wireless communication device 110, and memory 930 stores the instructions executed by processor 920. In a particular embodiment, transceiver 910 includes a first transmitter for communicating with the wireless devices 110 within a cluster 204 at a first frequency and a second transmitter for communicating with the serving radio network node 115 at a second frequency.

Processor 920 includes any suitable combination of hardware and software implemented in one or more modules to execute instructions and manipulate data to perform some or all of the described functions of wireless communication device 110. In some embodiments, processor 920 includes, for example, one or more computers, one or more central processing units (CPUs), one or more microprocessors, one or more applications, and/or other logic.

Memory 930 is generally operable to store instructions, such as a computer program, software, an application including one or more of logic, rules, algorithms, code, tables, etc. and/or other instructions capable of being executed by a processor. Examples of memory 930 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Other embodiments of wireless communication device 110 include additional components (beyond those shown in FIG. 10) responsible for providing certain aspects of the wireless communication device's functionality, including any of the functionality described above and/or any additional functionality (including any functionality necessary to support the solution described above).

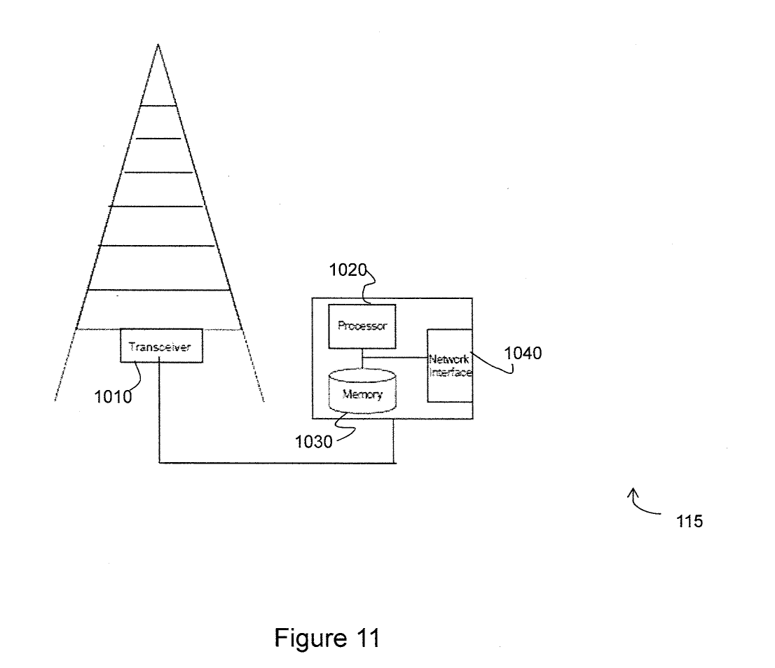

FIG. 11 is a block diagram illustrating embodiments of radio network node 115. In the illustration, radio network node 115 is shown as a radio access node, such as an eNodeB, a node B, a base station, a wireless access point (e.g., a Wi-Fi access point), a low power node, a base transceiver station (BTS), transmission points, transmission nodes, remote RF unit (RRU), remote radio head (RRH), etc. Other radio network nodes 115, such as one or more radio network controllers, may be configured between the radio access nodes and core network nodes 130. These other radio network nodes 120 may include processors, memory, and interfaces similar to those described with respect to FIG. 11, however, these other radio network nodes might not necessarily include a wireless interface, such as transceiver 510.

Radio access nodes are deployed throughout network 100 as a homogenous deployment, heterogeneous deployment, or mixed deployment. A homogeneous deployment generally describes a deployment made up of the same (or similar) type of radio access nodes and/or similar coverage and cell sizes and inter-site distances. A heterogeneous deployment generally describes deployments using a variety of types of radio access nodes having different cell sizes, transmit powers, capacities, and inter-site distances. For example, a heterogeneous deployment may include a plurality of low-power nodes placed throughout a macro-cell layout. Mixed deployments include a mix of homogenous portions and heterogeneous portions.

Radio network node 120 includes one or more of transceiver 1010, processor 1020, memory 1030, and network interface 1040. Transceiver 1010 facilitates transmitting wireless signals to and receiving wireless signals from wireless communication device 110 (e.g., via an antenna), processor 1020 executes instructions to provide some or all of the functionality described above as being provided by a radio network 120, memory 1030 stores the instructions executed by processor 1020, and network interface 1040 communicates signals to backend network components, such as a gateway, switch, router, Internet, Public Switched Telephone Network (PSTN), other radio network nodes 120, core network nodes 130, etc.

Processor 1020 includes any suitable combination of hardware and software implemented in one or more modules to execute instructions and manipulate data to perform some or all of the described functions of radio network node 120. In some embodiments, processor 1020 includes, for example, one or more computers, one or more central processing units (CPUs), one or more microprocessors, one or more applications, and/or other logic.

Memory 1030 is generally operable to store instructions, such as a computer program, software, an application including one or more of logic, rules, algorithms, code, tables, etc. and/or other instructions capable of being executed by a processor. Examples of memory 530 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 1040 is communicatively coupled to processor 1020 and refers to any suitable device operable to receive input for radio network node 120, send output from radio network node 120, perform suitable processing of the input or output or both, communicate to other devices, or any combination of the preceding. Network interface 1040 includes appropriate hardware (e.g., port, modem, network interface card, etc.) and software, including protocol conversion and data processing capabilities, to communicate through a network.

Other embodiments of radio network node 120 include additional components (beyond those shown in FIG. 11) responsible for providing certain aspects of the radio network node's functionality, including any of the functionality described above and/or any additional functionality (including any functionality necessary to support the solution described above). The various different types of radio access nodes may include components having the same physical hardware but configured (e.g., via programming) to support different radio access technologies, or may represent partly or entirely different physical components.

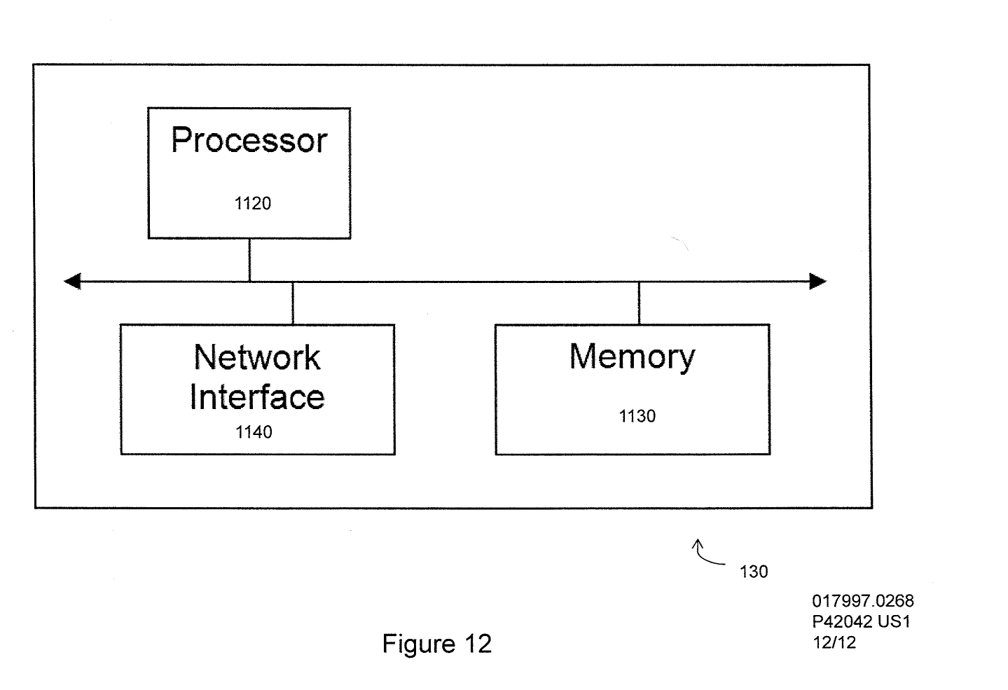

FIG. 12 is a block diagram illustrating a core network node 130. Examples of core network node 130 can include a mobile switching center (MSC), a serving GPRS support node (SGSN), a mobility management entity (MME), a radio network controller (RNC), a base station controller (BSC), and so on. Core network node 130 includes processor 1120, memory 1130, and network interface 1140. In some embodiments, processor 1120 executes instructions to provide some or all of the functionality described above as being provided by core network node 130, memory 1130 stores the instructions executed by processor 1120, and network interface 1140 communicates signals to an suitable node, such as a gateway, switch, router, Internet, Public Switched Telephone Network (PSTN), radio network nodes 120, other core network nodes 130, etc.

Processor 1120 includes any suitable combination of hardware and software implemented in one or more modules to execute instructions and manipulate data to perform some or all of the described functions of core network node 130. In some embodiments, processor 1120 includes, for example, one or more computers, one or more central processing units (CPUs), one or more microprocessors, one or more applications, and/or other logic.

Memory 1130 is generally operable to store instructions, such as a computer program, software, an application including one or more of logic, rules, algorithms, code, tables, etc. and/or other instructions capable of being executed by a processor. Examples of memory 1130 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 1140 is communicatively coupled to processor 1120 and may refer to any suitable device operable to receive input for core network node 130, send output from core network node 130, perform suitable processing of the input or output or both, communicate to other devices, or any combination of the preceding. Network interface 1140 includes appropriate hardware (e.g., port, modem, network interface card, etc.) and software, including protocol conversion and data processing capabilities, to communicate through a network.

Other embodiments of core network node 130 include additional components (beyond those shown in FIG. 12) responsible for providing certain aspects of the core network node's functionality, including any of the functionality described above and/or any additional functionality (including any functionality necessary to support the solution described above).

Some embodiments of the disclosure may provide one or more technical advantages. For example, certain embodiments may provide a more spectrally efficient implementation of Coordinated Multi-Point (CoMP) transmission of data. Another technical advantage may be improvement of individual and aggregate throughput in cellular systems (both LTE and Wi-Fi) by exploiting idle and active wireless devices to retransmit signals from active wireless devices. In addition to improving capacity and throughput, particular embodiments may also aid in eliminating coverage holes for wireless devices in poor coverage areas.

Still another technical advantage may be the mitigation of the high backhaul costs associated with using CoMP. For example, from a base station or other radio network node perspective, additional processing requirements related to UL and DL CoMP may be reduced or eliminated. According to particular embodiments, the clustering algorithm used to achieve the virtual MIMO gains may be implemented in a distributed manner that minimizes computational load at each radio network node. The clustering algorithm may also minimize bandwidth requirements between radio network nodes to achieve CoMP type gains.

Still another technical advantage may be the alleviation of interference by aggressor networks in a Wi-Fi implementation or co-channel interference for cell edge users in a 3GPP implementation.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

Abbreviations used in the preceding description include:

CoMP Coordinated Multipoint

UL Uplink

UE User Equipment

D2D Device-to-Device

AP Access Point

DM Discovery Mode

DMA Discovery Mode Activation

DMRS Digital Modulation Reference Signal

EA Eligible Assistant

MCS Modulation and Coding Scheme

PI Processing Interval

RB Resource Block

TB Transport Block

TP Transmit Period

VMIMO Virtual Multi Input Multi Output

1-20. (canceled)

21. A wireless communication device within a cluster of wireless devices, comprising:
a transceiver adapted to exchange with all wireless devices within the cluster data to be transmitted to respective serving nodes;
one or more processors for concatenating data exchanged with all devices in the cluster into a multiplexed data block; and
an antenna adapted to form a virtual multi-input multi-output (VMIMO) array with antennas of all wireless devices within the cluster and transmit the multiplexed data block,
wherein the cluster is formed based on one or more metrics.

22. The wireless communication device of claim 21, wherein the transceiver is adapted to exchange data with all wireless devices within the cluster using device-to-device local exchange.

23. The wireless communication device of claim 21, wherein the transceiver is adapted to exchange data with all wireless devices within the cluster over a first radio access technology (RAT) and exchange data with a radio network node over a second RAT.

24. The wireless communication device of claim 21, wherein the transceiver is adapted to exchange data with wireless devices within the cluster over a first transmission bandwidth range and exchange data with a radio network node over a second transmission bandwidth range.

25. The wireless communication device of claim 21, wherein formation of the cluster of wireless devices is network controlled in response to one or more messages from a radio network node.

26. The wireless communication device of claim 21, wherein the formation of the cluster of wireless devices is autonomous within the cluster of wireless devices without receiving a message from a radio network node.

27. The wireless communication device of claim 21, wherein the one or more processors is operable to act as a cluster head and autonomously select, based on the one or more metrics, the wireless devices included in the cluster.

28. The wireless communication device of claim 21, wherein the metrics used to form the cluster of wireless devices include channel quality information (CQI) of the wireless device as seen by a radio network node serving the wireless device.

29. The wireless communication device of claim 28, wherein the CQI is measured through the use of reference signal received power (RSRP) and reference signal received quality (RSRQ) measurements.

30. The wireless communication device of claim 21, wherein the metrics used to form the cluster of wireless devices include local device-to-device channel quality information (CQI) between wireless devices within the cluster.

31. The wireless communication device of claim 21, wherein the transceiver is adapted to exchange data with wireless devices within the cluster using a TDD network for device-to-device local exchange of data.

32. The wireless communication device of claim 21, wherein the transceiver is adapted to exchange data on an uplink using HD-FDD.

33. The wireless communication device of claim 21, wherein the one or more processors is adapted to form the multiplexed data block using concatenated demodulation reference signaling (DMRS).

34. A method in a wireless device, comprising:
exchanging, with all wireless devices within a cluster of wireless devices, data to be transmitted to each serving node serving a wireless device within the cluster of wireless devices;
concatenating the data exchanged with all wireless devices in the cluster into a multiplexed data block;
forming a virtual multi-input multi-output (VMIMO) array with a plurality of antennas of all wireless devices within the cluster; and
using the VMIMO array to transmit the multiplexed data block,
wherein the cluster is formed based on one or more metrics.

35. The method of claim 34, further comprising using device-to-device local exchange to exchange data with all wireless devices within the cluster.

36. The method of claim 34, further comprising:
using a first radio access technology (RAT) to exchange data with all wireless devices within the cluster; and
using a second RAT to exchange data with a radio network node.

37. The method of claim 34, further comprising:
using a first transmission bandwidth range to exchange data with wireless devices within the cluster; and
using a second transmission bandwidth range to exchange data with a radio network node.

38. The method of claim 34, wherein formation of the cluster of wireless devices is network controlled in response to one or more messages from a radio network node.

39. The method of claim 34, wherein the formation of the cluster of wireless devices is autonomous within the cluster of wireless devices without receiving a message from a radio network node.

40. The method of claim 34, further comprising wherein the wireless device acts as a cluster head and autonomously selects, based on the one or more metrics, the wireless devices included in the cluster.

41. The method of claim 34, wherein the metrics used to form the cluster of wireless devices include channel quality information (CQI) of the wireless device as seen by a radio network node serving the wireless device.

42. The method of claim 41, wherein the CQI is measured through the use of reference signal received power (RSRP) and reference signal received quality (RSRQ) measurements.

43-49. (canceled)

50. A radio network node, comprising:
one or more processors; and
memory containing instructions executable by the one or more processors whereby the radio network node is operable to:
transmit, to a plurality of wireless devices, a first request for initiation of a discovery mode;
receive, from each of the plurality of wireless devices, channel quality information indicating a quality of each device-to-device communication channel;
select, based on one or more similarity metrics applied to the channel quality information received from each wireless device, a portion of the plurality of wireless devices for formation of a device-to-device cluster;
transmit, to the wireless devices selected for the formation of the device-to-device cluster, a second request for the formation of the device-to-device cluster; and
receive, from a virtual MIMO array formed by the device-to-device cluster, a composite data message.

51. The radio network node of claim 50, wherein the channel quality information comprises:
a channel quality indicator message received from each of the plurality of wireless devices, the channel quality indicator message identifying a bandwidth that a particular one of the plurality of wireless devices will use to transmit a signal to other ones of the plurality of wireless devices.

52. The radio network node of claim 51, wherein the radio network node is further operable to minimize Coordinated Multi-Point (CoMP) backhaul requirements by:
determining that the radio network node is able to decode one or more wireless devices that the radio network node is serving within the device-to-device cluster;
send an acknowledgement (ACK) to one or more additional radio network nodes in a CoMP set of the device-to-device cluster; and thereafter
only send data over X2 to the one or more additional radio network nodes for data that was not acknowledged by a serving radio network node.

53. A system comprising:
a first cluster of a first plurality of wireless devices, the first cluster being formed based on one or more similarity metrics, each of the first plurality of wireless devices operable to:
exchange data with all wireless devices within the first cluster;
concatenate the data exchanged with all devices in the first cluster into a multiplexed data block; and
form a virtual multi-input multi-output (VMIMO) array with antennas of all wireless devices within the first cluster and transmit the multiplexed data block; and
at least one radio network node operable to receive, from the virtual MIMO array formed by first cluster of wireless devices, the composite data message.

54-58. (canceled)
